(19) United States
(12) Patent Application Publication
(10) Pub. No.: US 2025/0242315 A1
(43) Pub. Date: Jul. 31, 2025

(54) CARBON DIOXIDE DISSOLUTION DEVICE AND CARBON DIOXIDE DISSOLUTION SYSTEM COMPRISING SAID DEVICE

(71) Applicant: ECOBOX LIMITED, London (GB)

(72) Inventor: Javier Hernan BLANCO, Monte Grande (AR)

(21) Appl. No.: 19/041,421

(22) Filed: Jan. 30, 2025

Related U.S. Application Data
(60) Provisional application No. 63/626,837, filed on Jan. 30, 2024.

(51) Int. Cl. B01F 21/20; B01F 21/00; B01F 35/21

(52) U.S. Cl. CPC B01F 21/20; B01F 21/30; B01F 35/2113

(57) ABSTRACT

A dissolution device comprising a tubular body comprising an inlet, an outlet and a side duct, said tubular body further comprising a first chamber fluidly connected to the side duct, and a second chamber fluidly connected to said first chamber through a chamber junction conduit; and a central body comprising an inlet portion and an outlet portion, said central body being located within the tubular body and attached to said tubular body; wherein the tubular body and the central body define a passage therebetween through which fluid can flow, wherein the first chamber is further fluidly connected to the passage through a first inner conduit and to an exterior of the tubular body through the side duct, and the second chamber is fluidly connected to the passage through a second inner conduit, and wherein the dissolution device comprises two gas dissolution zones. A dissolution system comprising said the dissolution device and a stabilizer tank fluidly connected to the dissolution device.

### FIELD OF THE INVENTION

The present invention relates to the technical field of carbon dioxide dissolution equipment. More specifically, the present invention relates to a carbon dioxide dissolution device and carbon dioxide dissolution system comprising said device, wherein said device and system allow the dissolution of carbon dioxide (CO₂) in a liquid (beverage) to obtain, for example, a carbonated beverage.

### BACKGROUND OF THE INVENTION

Carbonation, i.e. the addition of CO₂ to liquids, is an essential process in the preparation of carbonated beverages. This gas plays a crucial role in defining the sensory properties of carbonated beverages, contributing significantly to taste, aroma and, through the formation of bubbles, visual appearance. The relevance of carbon dioxide goes beyond mere aesthetics, influencing the tactile experience on the tongue and palate. In this context, the quality of carbonation becomes a distinguishing factor that directly impacts consumer appreciation and market competitiveness and, therefore, the effective dissolution of carbon dioxide emerges as a determining factor for excellence in carbonated beverage production.

In the prior art there are devices such as those described in the patent applications US 2013/037973 A1, US 2016/0120209 A1 and US 2019/0083946 A1. More precisely, patent applications US 2013/037973 A1 and US 2016/0120209 A1 are directed to a variable pressure device to solubilize carbon dioxide in a beverage and a method for solubilizing carbon dioxide in a beverage using a variable pressure device, respectively. Patent application US 2019/0083946 A1 disclose a carbonation duct for blending a gas and a beverage, comprising a tubular structure surrounding a compression structure that is positioned inside the tubular structure and sets a pathway for the flowing of the beverage along the carbonation duct, wherein said pathway comprises a convergence path, a mixture path and a slowdown path along the carbonation duct.

These devices, as well as other devices and systems known in the state of the art, have one or more of the following technical disadvantages, they do not allow high CO₂ dissolution efficiencies in the liquid; they have high pressure losses and therefore require more energy; and they require carbonating the liquid at temperatures of 18° C. or lower, otherwise the beverage becomes unstable in the filling process and foaming (gas release) occurs.

Therefore, there is a need to provide a carbon dioxide dissolution device and carbon dioxide dissolution system that address each of the above technical disadvantages, i.e. that allows high CO₂ dissolution efficiencies in the liquid; has low pressure losses and reduced energy consumption; and can carbonate the liquid at higher temperatures without destabilizing the beverage and avoiding the generation of foam.

### BRIEF DESCRIPTION OF THE INVENTION

Based on the foregoing considerations, the present invention provides a carbon dioxide dissolution device and carbon dioxide dissolution system that allow high CO₂ dissolution efficiencies in the liquid; has low pressure losses and reduced energy consumption; and can carbonate the liquid at higher temperatures without destabilizing the beverage (or carbonated liquid) and avoiding the generation of foam, amongst other advantages.

Accordingly, in a first aspect, it is an object of the present application a dissolution device comprising:
a tubular body comprising an inlet, an outlet and a side duct, said tubular body further comprising:
   a first chamber fluidly connected to the side duct, and
   a second chamber fluidly connected to said first chamber through a chamber junction conduit; and
a central body comprising an inlet portion and an outlet portion, said central body being located within the tubular body and attached to said tubular body;
   wherein the tubular body and the central body define a passage therebetween through which fluid can flow,
   wherein the first chamber is further fluidly connected to the passage through a first inner conduit and to an exterior of the tubular body through the side duct, and the second chamber is fluidly connected to the passage through a second inner conduit, and
   wherein the dissolution device comprises two gas dissolution zones.

In an embodiment of the device of the present invention, the first chamber, the second chamber and the chamber junction conduit surround a longitudinal axis of the dissolution device in an annular manner.

In an embodiment of the device of the present invention, the central body comprises at a longitudinal end thereof an impact head where the fluid entering the tubular body through the inlet impacts.

In a preferred embodiment of the device of the present invention, the impact head comprises an angle of attack between 16° and 20°.

In an embodiment of the device of the present invention, the passage comprises:
a first passage section extending from the impact head to the first inner conduit where the passage narrows as it approaches said first inner conduit, reaching a minimum width in the area where the passage and the first inner conduit connect, such narrowing of the passage occurring due to a widening of the inlet portion of the central body;
a second passage section extending from the first inner conduit to the second inner conduit, where the width remains constant for part of the second passage section and then gradually widens again as it approaches the second inner conduit as the width of the inlet portion of the central body becomes narrower, and wherein once the passage reaches the area where said passage and the second inner conduit connect, the passage widens or expands abruptly since the inner diameter of the tubular body increases; and
a third passage section extending from the second inner conduit, specifically from the abrupt widening of the passage, to an end of the outlet portion of the central body, wherein said third passage section remains substantially the same volume for a part of the outlet portion of the central body, and then widens as the outlet portion of the central body narrows towards the outlet of the tubular body.

In an embodiment of the device of the present invention, the first inner conduit has an inlet angle of between 60° and 75°.

In an embodiment of the device of the present invention, the second inner conduit comprises an upper surface having two surface sections inclined in opposite directions, each of said surface sections being defined by an angle, and said two surface sections generating a point of contact for greater discharge. Preferably, each of said surface sections is defined by an angle ranging from 15° to 20°.

In an embodiment of the device of the present invention, the two gas dissolution zones comprise a first gas dissolution zone define by the zone where the first inner conduit flows into the passage, and a second gas dissolution zone define by the zone where the second inner conduit flows into the passage.

In a second aspect, it is an object of the present application a dissolution system comprising:
the dissolution device according to the first aspect, said dissolution device being fluidly connected to a liquid container through liquid supply means; and
a stabilizer tank fluidly connected to the dissolution device through the outlet of said dissolution device, said stabilizer tank being fluidly connected to a gas tank through gas supply means; and further fluidly connected to the side duct of the dissolution device.

In an embodiment of the system of the present invention, the stabilizer tank comprises a pressure sensor.

In an embodiment of the system of the present invention, the liquid supply means comprise a pump.

### BRIEF DESCRIPTION OF THE FIGURES

FIG. 1 shows a cross-section view of the carbon dioxide dissolution device of the present invention.

FIG. 2 shows a cross-section view of a portion of the carbon dioxide dissolution device of the present invention, further illustrating how each of the fluids flow within said device.

FIG. 3 shows a cross-sectional view of the carbon dioxide dissolution device of the present invention together with an enlarged view of the second internal conduit.

FIG. 4 shows the geometry of the second inner conduit of the carbon dioxide dissolution device of the present invention compared to a conduit of equivalent function of the prior art.

FIG. 5 shows a cross-sectional view of the carbon dioxide dissolution device of the present invention.

FIG. 6 shows a schematic view of the carbon dioxide dissolution system of the present invention.

### DETAILED DESCRIPTION OF THE INVENTION

The carbon dioxide dissolution device and carbon dioxide dissolution system will be described in detail below.

As used herein, the expressions “dissolution device”, “carbon dioxide dissolution device”, “carbonation device” and the like are used interchangeably to refer to a device that allows the dissolution of carbon dioxide in a liquid to obtain a carbonated liquid, for example, a beverage or soft drink. Similarly, the expressions “dissolution system”, “carbon dioxide dissolution system”, “carbonation system” and the like are used interchangeably to refer to a system which allows the dissolution of carbon dioxide in a liquid to obtain a carbonated liquid, for example, a beverage or soft drink.

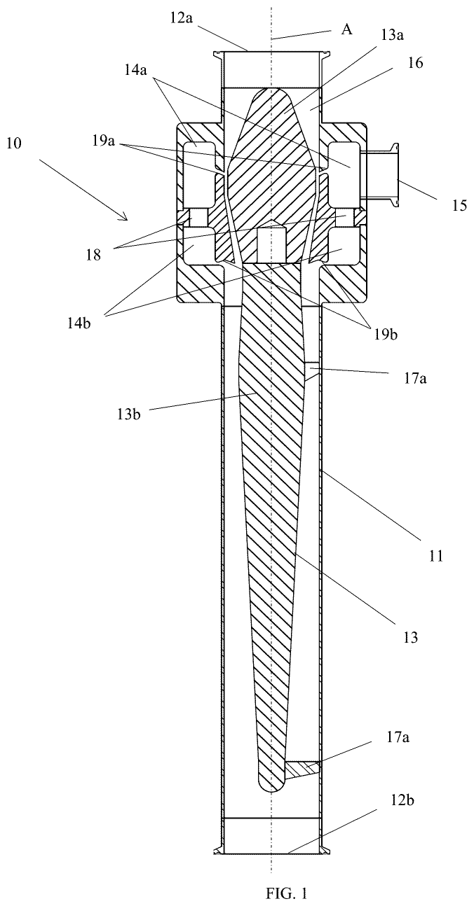

Referring to FIG. 1, a cross-section view of the dissolution device 10 of the present invention is shown. Particularly, the dissolution device 10 comprises a tubular body 11 having an inlet 12a and an outlet 12b, a central body 13, a first chamber 14a, a second chamber 14b, a side duct 15 and a passage 16.

The tubular body 11 surrounds the central body 13, said central body 13 being attached to an inner surface of the tubular body 11 by means of brackets or supports 17a, 17b. In other words, said central body 13 is located within the tubular body 11.

Between the central body 13 and the tubular body 11 there is a space, specifically, between an inner surface of the tubular body 11 and an outer surface of the central body 13, which defines the passage 16 through which a fluid (liquid, gas or a mixture thereof) that enters through the inlet 12a passes until exiting through the outlet 12b, wherein said inlet 12a is located at one end of the tubular body 11 and the outlet 12b is located at another end of the tubular body 11, said ends being longitudinally opposite.

The tubular body 11 comprises in its interior a first chamber 14a and a second chamber 14b defining hollow volumes surrounding a dissolution device longitudinal axis A in an annular shape, wherein said first chamber 14a and second chamber 14b are fluidly connected to each other via a chamber junction conduit 18, and wherein said chamber junction conduit 18 also defines a hollow volume surrounding the longitudinal axis A. The first chamber 14a, the second chamber 14b and the chamber junction conduit 18 form a carbonation ring, i.e. an inner volume of the tubular body 11 surrounding the central body 13 and containing inside it pressurized gas (carbon dioxide) which will be used to carbonate the fluid passing through the passage 16.

The first chamber 14a is further fluidly connected to the passage 16 through a first inner conduit 19a and to the outside of the tubular body 11 through the side duct 15 located on the outer surface of the tubular body 11. For its part, the second chamber 14b is fluidly connected to the passage 16 through a second inner conduit 19b.

The side duct 15 can be fluidly connected via a pipe to a stabilizer tank containing gas, e.g. carbon dioxide (CO₂), and carbonated liquid, e.g., a beverage. Particularly, the side duct 15 allows the gas (solute), e.g. CO₂, within the tank to enter the first chamber 14a and also, due to the chamber junction conduit 18, to the second chamber 14b.

The central body 13, also referred to as a “directing body”, comprises an inlet portion 13a (also known as “bullet head” due to its shape) and an outlet portion 13b, wherein the central body 13 comprises at a longitudinal end thereof, specifically at the end closest to the inlet 12a (i.e. at the inlet portion 13a), an impact head where the fluid entering the tubular body 11 through the inlet 12a impacts.

Considering the direction of flow, i.e. a direction from the inlet 12a to the outlet 12b, the passage 16 comprises a first passage section, a second passage section and a third passage section. The first passage section extends from the impact head to the first inner conduit 19a where the passage 16 narrows as it approaches said first inner conduit 19a, reaching a minimum width (i.e., a minimum cross-section surface of the passage) in the area where the passage 16 and the first inner conduit 19a connect (i.e., where the first inner conduit 19a flows into the passage 16), such narrowing of the passage 16 occurring due to a widening of the inlet portion 13a of the central body 13.

The second passage section extends from the first inner conduit 19a to the second inner conduit 19b, where the width (i.e., the cross-section surface of the passage) remains constant for part of the second passage section and then gradually widens again as it approaches the second inner conduit 19b as the width of the inlet portion 13a of the central body 13 becomes narrower. Once the passage 16 reaches the area where said passage and the second inner conduit 19b connect (i.e., where the second inner conduit 19b flows into the passage 16), the passage widens or expands abruptly since the inner diameter of the tubular body 11, as defined by the inner surface of the tubular body, increases.

Finally, the third passage section extends from the second inner conduit 19b, specifically from the abrupt widening of the passage mentioned above, to the other end of the central body 13 (i.e., an end of the outlet portion 13b of the central body 13). The third passage section of the passage 16 remains substantially the same volume (i.e., the cross-section surface of the passage is substantially constant) for a part of the outlet portion 13b of the central body, and then widens (or increases in volume) as the outlet portion of the central body narrows towards the outlet of the tubular body 11.

Thus, the fluid entering the device 11, said fluid being a liquid, after impacting the impact head passes through the first passage section of the passage 16 where the liquid is progressively accelerated and this acceleration generates a loss of pressure in the area where the first inner conduit 19a flows into the passage 16, i.e. the second passage section. This loss of pressure (compared to the pressure at which the fluid entered the device) or vacuum generates a pressure difference that allows the gas (carbon dioxide) that is, for example, in the stabilizer tank to enter the first chamber 14a and distribute itself along the first chamber 14a (it also enters to the second chamber 14b and distributes therein) and, once in the first chamber 14a, to pass through the first inner conduit 19a and enter the passage 16, thus mixing with the liquid and resulting in the dissolution of the CO₂ in the liquid. This zone is thus a first dissolution zone or first carbonation zone.

The fluid, which at this stage corresponds to a mixture of liquid with dissolved CO₂ (i.e., a carbonated liquid), continues to flow through the second passage section until it enters the third passage section, where the widening or expansion of the passage 16 generates an expansion in the fluid that generates a new vacuum condition or pressure drop, since the velocity of the liquid that was passing through the second passage section must be compensated by the entry of gas to conserve the energy of the liquid displacement, and allows the gas (carbon dioxide) that is in the second chamber 14b to pass through the second inner conduit 19b and enter the passage 16, thus mixing with the fluid and resulting in the dissolution of the CO₂, and thus generating a second dissolution zone or second carbonation zone.

Finally, the fluid (carbonated liquid) passes through the outlet portion 13b of the central body 13, where the outlet portion 13b is shaped like a tail to achieve the progressive deceleration of the fluid in order to help the fluid retain the solubilized gas and equalize its subsequent speed to the speed that the fluid had at the inlet 12a of the device to then leave the passage 16 and the tubular body 11 through the outlet 12b and enter the stabilizer tank.

Regarding the geometry and shape of the device 10, it should be noted that said device 10, except for the supports 17a, 17b and the side duct 15, is a solid of revolution.

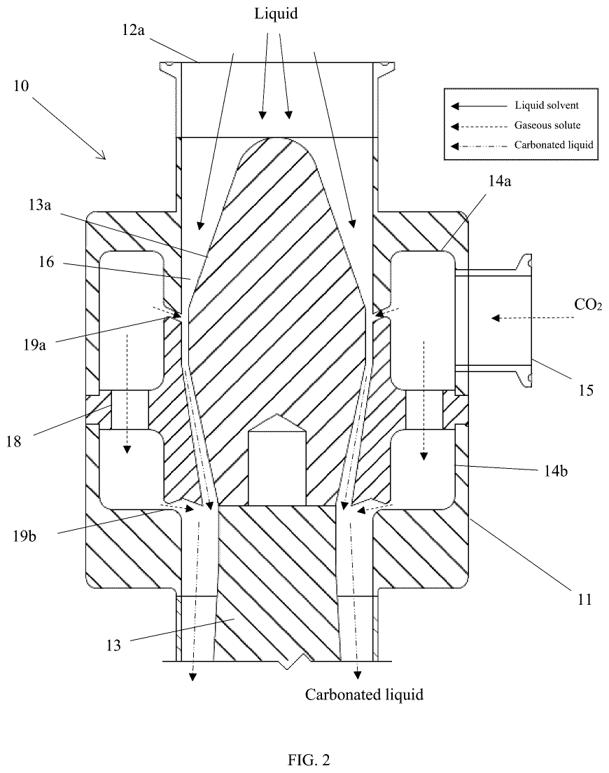

FIG. 2 shows clearly what is described above, i.e., how each of the fluids (liquid, gas and carbonated liquid) flow within the tubular body 11, each of said fluids having a certain type of arrow to distinguish them and indicate the direction of flow.

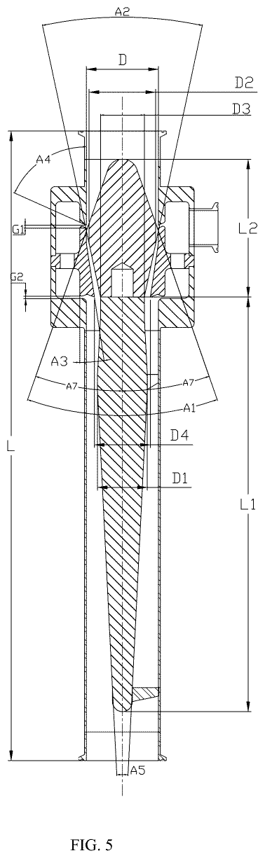

It should be noted that the impact head of the central body 13 comprises an angle of attack for the fluid entering the device 10 that allows the fluid to be directed annularly through the interior of the tubular body 11, i.e. through the passage 16. The angle of attack is preferably between 16° and 20° (see reference A7, corresponding to said angle of attack, in FIG. 5). This angle of attack makes it possible to prolong and increase the contact of the fluid with the impact head of the central body, which reduces the pressure loss of the fluid when it enters the tubular body 11 compared to the devices known in the state of the art. This decrease in pressure loss reduces the energy required for the fluid to pass through the narrowing zone of the passage 16.

This decrease in pressure drop is based on the theory of superposition of effects where the impact of the fluid at the impact head generates the superposition of waves on the first passage section decreasing the pressure drop (i.e., turbulence is deceased) as the fluid (liquid) enters the first dissolution zone which is inside the second passage section.

It should be noted that any increase in pressure drop implies an increase in kinetic energy and, consequently, a loss of efficiency in the dissolution of the gas in the liquid. In this way, the device of the present invention allows to have a better efficiency in the dissolution of the gas in the liquid since, while in the impact head of the devices known in the state of the art the pressure drop is in average about 800 g/cm², the pressure drop due to the angle of attack on the impact head of the central body of the device of the present invention allows to reduce the pressure drop to 300-390 g/cm².

The device 10 of the present invention thus allows the dissolution of the gas (carbon dioxide) in two dissolution steps, a first dissolution step defined by the first dissolution zone and a second dissolution step defined by the second dissolution zone.

The first dissolution step allows a progressive incorporation of the gas into the fluid (liquid) and, therefore, less agitation of the mixture that occurs between the liquid and the gas, where such agitation (which is equivalent to pressure loss) during carbonation (i.e. the mixing of the gas in the liquid so that the gas dissolves in the liquid), increases the kinetic energy of the gas causing greater foaming (release of gas) in the carbonation process. In addition, this first dissolution step allows higher carbonation values to be reached with temperatures between 20° C. and 24° C., even up to 28° C., whereas with the dissolution devices known in the state of the art it is not possible to reach a temperature of more than 16° C. for carbonation because at higher temperatures the fluid becomes very unstable and the release of gas and foaming is generated.

Therefore, the first dissolution step avoids having to cool the liquid or, in other words, to work with colder fluids, as in the devices known in the state of the art, to increase the efficiency of carbonation since, as Henry's law states, the solubility of a gas in a liquid increases as the temperature of the liquid decreases.

The first inner conduit 19a has a gas inlet angle of between 60° and 75° (see reference A4, corresponding to said gas inlet angle, in FIG. 5), allowing this range of inlet angle values a better gas drag due to two effects, said effects being the pressure loss generated by the increase of the fluid velocity (i.e., the tangential velocity of the fluid passing through the space between the bullet head and the inner surface of the tubular body, wherein said fluid is accelerated as it passes through this part of the passage due to the reduction of the section), and the action of the vacuum caused by the fluid displacement.

The second dissolution step allows a higher solubility of the gas in the liquid to be achieved without generating excessive turbulence, i.e. increased kinetic energy in the gas which results in a loss of efficiency in dissolving the gas in the liquid.

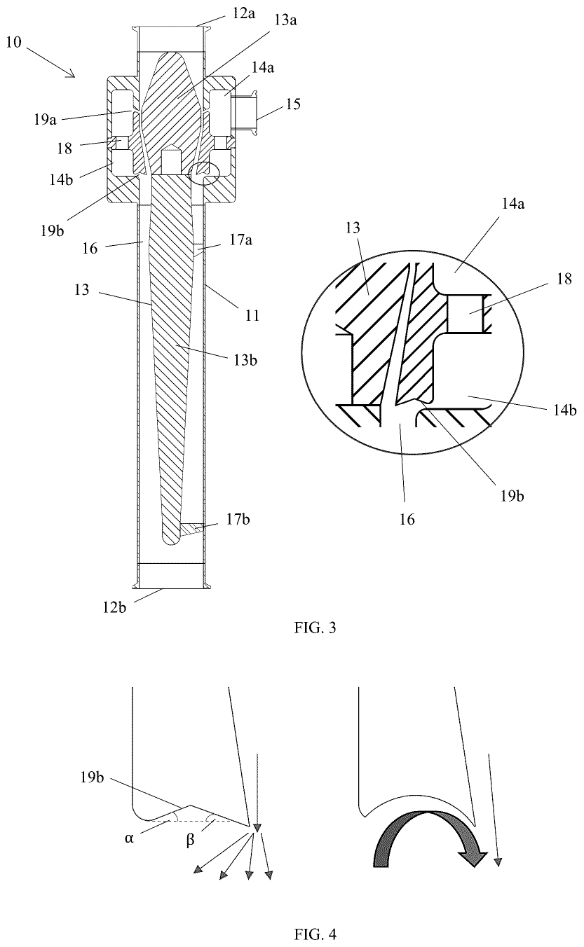

As can be seen in FIGS. 3 and 4, the second inner conduit 19b comprises an upper surface (i.e., an upstream surface) having two surface sections inclined in opposite directions, each of said surface sections being defined by an angle (angles α and β) ranging from 15° to 20°, and said two surface sections generating a point of contact with the liquid with a greater discharge.

More precisely, in FIG. 4 the drawing on the left corresponds to the design of the upper surface of the second inner conduit 19b of the device of the present invention, where the angles α, β of the surface sections ensure the projection and expansion of the fluid in straight lines, while the drawing on the right corresponds to the design of the conduits for the incorporation of gas in the fluid (liquid) known in the prior art, where the expansion of the liquid is in a spiral manner which generates greater turbulence and agitation of the liquid and the gas, thus, a lower dissolution efficiency.

This change in the geometry of the second inner conduit 19b makes it possible to increase the filling temperature from 14° C. (mean temperatures used in the devices of the prior art) to 20° C.-24° C., even up to 28° C., with greater stability of the carbonated fluid at the time of filling.

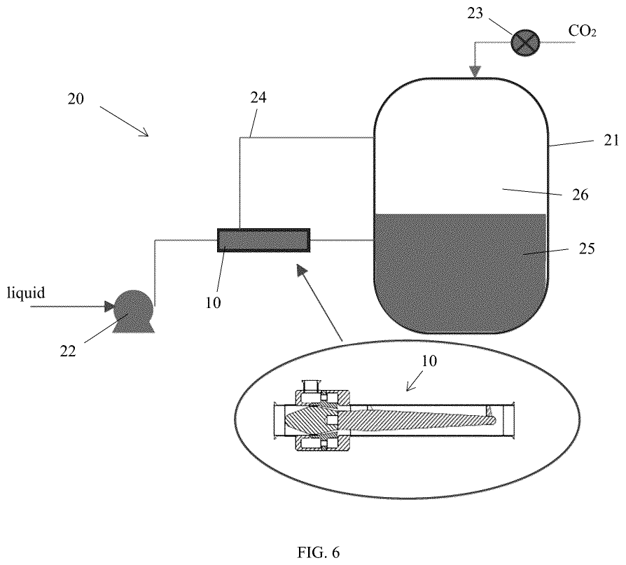

FIG. 6 shows the carbon dioxide dissolution system 20 of the present invention comprising the dissolution device 10, a stabilizer tank 21, gas supply means (not shown) and liquid supply means 22.

In said system 20, the dissolution device 10 is fluidly connected through its inlet and a corresponding pipe to the liquid supply means 22, wherein said liquid supply means 22 are in turn fluidly connected to an external liquid container (not shown); and fluidly connected through its outlet and a corresponding pipe to the stabilizer tank 21. The tank 21 is fluidly connected through an upper part thereof and a corresponding pipe to gas supply means, wherein said gas supply means are in turn fluidly connected to an external gas tank and wherein said gas supply means supply carbon dioxide at a pressure ranging from 6 bar to 10 bar to the tank. The tank is also fluidly connected to the side duct of the device 10 through a pipe 24.

The pipe 24 fluidly connects the top of the tank containing pressurized gas (coming from the pipe fluidly connected to the gas supply means) to the inlet of the carbonation ring through the side duct 15 of the dissolution device 10. Preferably, the pipe 24 is connected to the side of the tank at a height corresponding to the 90% of the tank height. As the fluid passes through the area where the passage 16 and the first inner conduit 19a (which corresponds with an inlet to the carbonating ring) are connected, a pressure drop (vacuum) is generated at the inlet of the side duct 15 which, being connected to the top of the tank, generates a pressure drop at the top of the tank which is detected by a pressure sensor located within the stabilizing tank 21. This pressure sensor allows to compensate this pressure drop by opening a valve 23 (i.e., the valve and the pressure sensor are communicated) that allows pressurized carbon dioxide, coming from the gas supply means, to enter the tank in order to re-establish the pressure inside the tank to a predefined working pressure (i.e., a predefined pressure set by a user to carry out carbonation), thereby ensuring that the system 20 works at constant pressure. In other words, the pressure sensor allows the system 20, specifically the device 10 and the tank 21, to work at constant pressure, which in turn allows a certain volume of gas to be dissolved in the liquid. As is it will be apparent to a person skilled in the art, if the pressure is constant, the volume of gas dissolved in the liquid is also constant.

The liquid supply means 22 comprise a pump responsible for conveying the fluid (liquid) and raising its pressure to overcome the pressure in the stabilizer tank.

The stabilizer tank thus comprises three conduits that allow the entry or exit of fluids from therein, said three conduits being a first conduit that allows the entry of the carbonated fluid (for example, a beverage), a second conduit that allows the entry of carbon dioxide gas, and a third conduit that allows directing carbon dioxide gas to the device 10 through its side duct.

The first conduit of the tank allows the entry of the carbonated fluid at a height or level of preferably 30% of the height of the tank.

The inner volume of the tank (V_{Tank}) corresponds to the maximum flow rate (Qₘₐₓ) of the fluid pumped by the pump, according to sizing sections of the system, divided by 20, i.e. according to the equation:

$${V}_{Tank} = \frac{{Q}_{max}}{20}$$

It should be noted that the device of the present invention is preferably sized according to the diameter of the main passage section or pipe diameter D (shown in FIG. 5), which corresponds to the diameter of the inlet and outlet of the device of the present invention, wherein said diameter D responds to the flow rate entering through the first conduit of the tank, i.e., the flow rate passing through the device of the present invention and pumped by the pump, preferably according to Table 1 shown below.

TABLE 1

| $Volume flow rate ( \frac{{m}^{3}}{h} )$ | Diameter D (inches) |
|---|---|
| 1-5 | 1.5 |
| 5-20 | 2 |
| 20-35 | 3 |
| 35-60 | 4 |

Once the diameter D is determined, all of the following measurements or dimensions of the device of the present invention shown in Table 2 can be obtained as a function of said diameter D (in millimeters), and where each of said measurements are shown in FIG. 5. In this way, a constant relationship is maintained between the pipe diameter D and the various dimensions or measurements of the system.

TABLE 2

| Measurement | Value |
|---|---|
| L | 9 × D |
| L1 | 6 × D |
| L2 | 2 × D |
| D1 | 0.7 × D |
| D2 | 0.9 × D |
| D3 | 0.55 × D |
| D4 | 0.75 × D |
| G1 | 0.04 × D |
| G2 | 0.03 × D |
| A1 | 30° + (0.08 × D) |
| A2 | 20° + (0.1 × D) |
| A3 | 7° + (0.05 × D) |
| A4 | 60° + (0.1 × D) |
| A5 | 4° + (0.04 × D) |
| A7 | 15° + (0.04 × D) |

Therefore, the system 20 allows to carry out a process of dissolution of carbon dioxide in a liquid (solvent) which is pumped by means of the pump to the interior of the tank at a given speed and flow rate, passing in between through the dissolution device 10 of the present invention. In said dissolution device, the liquid passing through it undergoes an acceleration which makes it possible to generate the vacuum necessary to draw the gas (solute) from the top or upper part of the tank 21 through the pipe 24 fluidly connecting the stabilizing tank with the side duct of the device. In particular, the gas (CO₂) is incorporated into the liquid in a 1 to 1 ratio (volume of liquid over volume of gas).

In the first dissolution step, 40% of the total volume of the gas (carbon dioxide) is dissolved in the liquid, and then the remaining 60% of the total gas volume is dissolved in the liquid in the second dissolution step, wherein said 40% and 60% added together correspond to 100% of the theoretical volume of gas capable of dissolving in a given volume of liquid at the predefined working pressure. In other words, the system and device of the present invention allow to obtain a 1 to 1 ratio (or 1:1 ratio) of volume of liquid (solvent) over volume of gas (solute) in a continuous mixing process, where said 1 to 1 ratio means that for a given volume of liquid, a volume of gas corresponding to the theoretical maximum amount of gas that can be dissolved in said volume of liquid at a given pressure is effectively dissolved in said volume of liquid. This 1 to 1 ratio is achieved due to the design of the dissolution device of the present invention which allows, by means of its two inner chambers (i.e., the carbonation ring) which perform the dissolution of the carbon dioxide in two dissolution steps, to obtain a carbon dissolution efficiency greater than 97%, even greater than 99,9%, wherein by dissolution efficiency should be understood the amount of gas dissolved in the liquid that is achieved in practice compared to the maximum amount of gas that can be dissolved in the liquid according to theory for the same pressure value.

It should be noted that the tank pressure determines the volume of gas dissolved in the liquid in a 1 to 1 relationship with the tank pressure according to Boyle's law. Thus, in case the pressure in the tank is 1 bar, this means that there is one volume of dissolved gas (carbon dioxide) corresponding to, according to Avogadro's law, 1.987 grams of gas per liter of the volume of the carbonated fluid; if the pressure in the tank is 2 bar, this means that there are two volumes of dissolved gas corresponding to 3.974 grams of gas per liter of the volume of the carbonated fluid (in other words, if the pressure in the tank is increased from 1 bar to 2 bar, twice as many moles of gas will be present in a same volume), and so on. This 1 to 1 ratio, as established by theory, is due to the efficiency achieved by the solubilization system of more than 97%, even more than 99,9%.

It should be noted that if the pressure in the tank (i.e., the working pressure which is kept constant by the pressure sensor) is other than 1 bar, for example 2 bar, the ratio between the volume of dissolved gas and the volume of liquid will be still 1 to 1 due to the dissolution efficiency greater than 97%, even greater than 99,9%, that allows dissolving for said pressure of 2 bar the theoretical amount of carbon dioxide in a given volume of liquid (i.e., in this case 3.974 g of carbon dioxide per liter of the volume of the carbonated fluid) since, as described above, said ratio 1 to 1 is a ratio between the volume of gas corresponding to the theoretical maximum amount of gas that can be dissolved in a given volume of liquid at a given pressure (in this case 2 bar) and that, by means of the device and system of the present invention, is effectively achieved.

When a liter of carbonated fluid (mixture of liquid with dissolved gas) enters the tank 21, this carbonated fluid 25 (for example, a beverage) instead of compressing the gas 26 at the top of the tank 21, it displaces the gas through the supply pipe 24 to the carbonation device 10 in the same ratio (i.e., one liter of gas), thereby having a balance between the thrust of the carbonated fluid entering the tank, and the vacuum generated in the first and second inner conduits of the device because of the acceleration of the fluid flowing through the passage of the device. Therefore, the efficiency in the generation of vacuum allows reaching a balance between the volume of beverage entering the tank and the volume of gas displaced by the liquid (carbonated fluid or beverage) entering the tank.

To the effect of the vacuum generated in the dissolution device of the present invention is added the dissolution effectiveness of the system, where in the dissolution of the carbon dioxide that is achieved with said device the generation of turbulence (kinetic energy) is avoided. Avoiding the generation of turbulence prevents the release of dissolved gas when the carbonated liquid enters the tank, which is an undesirable effect since it would cause an increase in pressure in the tank and would not keep the previously configured working pressure constant.

The variation of the volume of gas dissolved in the carbonated liquid is achieved by increasing the tank pressure, since increasing the tank pressure increases the number of moles of gas for the same volume of carbonated liquid. In this way, the system 20 does not need a control system to achieve the dosage of CO₂ in the liquid, but simply the selection of the working pressure (tank pressure) and the monitoring of said pressure by means of the pressure sensor, the rest being a physical condition. It is for this reason that, if the flow rate of the fluid in the dissolution device is increased or decreased, the volume of gas dosed (supplied through the side duct 15) will increase or decrease proportionally.

The system of the present invention allows maintaining the 1 to 1 ratio between the pressure and the volume of dissolved gas as long as the flow rate entering the dissolution device is within 30% to 100% of the sizing flow rate, said sizing flow rate being selected in the ranges of values shown in Table 1 according to the value of the diameter D.

The incorporation of the gas in two dissolution steps provides differential advantages over the devices and systems known in the prior art. The incorporation of carbon dioxide gas into the fluid (i.e., the carbonation of the fluid) can be carried out at temperatures between 20° C. and 24° C., even up to 28° C., while in the carbonation devices known in the prior art which incorporate CO₂ in a single step, it is not possible to exceed 18° C. without generating instability of the beverage in the subsequent filling, making it necessary to reduce the temperature of the beverage (i.e., it is necessary to cool the beverage) to achieve stability. Additionally, having two dissolution steps allow obtaining higher beverage stability (lower kinetic energy in the gas) which allows to increase the filling rate by more than 15% of the beverage in a bottle (i.e., during filling).

In other words, the double carbonation or dissolution step condition provides greater efficiency in gas solubilization, less kinetic energy in the mixing process (less agitation) and therefore greater stability of the beverage (less foaming in the filling).

It should be understood that when the gas is not correctly distributed and solubilized in the beverage, it is released as the liquid is transferred from the carbonation (mixing) process to the subsequent filling process. This gas release generates foaming in the filling process which causes inefficient filling of bottles and, consequently, beverage waste; and/or slowing down of the filling process to mitigate foaming and therefore inefficiency in the production of carbonated beverages (which is equivalent to economic losses).

The acceleration of the liquid when passing through the first inner conduit and the second inner conduit, allows to generate CO₂ solubilization without the requirement of decreasing the temperature (i.e., cooling) of the fluid (solvent) to maximize or ensure dissolution (Henrry's Law), unlike the devices and systems known in the art.

Another advantage is that the pressure loss required to achieve optimum flow rate for carbonation is at least 45% less than that of the systems and devices known in the prior art. In particular, while in the systems and devices of the prior art the pressure loss is greater than 750 g/cm², in the device of the present invention the pressure drop is between 300 g/cm² and 390 g/cm².

Other advantages are the greater structural strength of the device of the present invention due to the angle of attack of the impact head of the central body of the device of the present invention since the angles of attack of the devices of the prior art are greater and cause frequent breakage of the brackets of the central body; and the increased vacuum level in the first chamber which is about 710 mmHg, while in the devices of the prior art it is 550 mmHg, whereby the device of the present invention allows improved efficiency of gas dissolution.

Finally, another advantage of the device and system of the present invention is that, while the devices and systems known from the state of the art allow a dissolution efficiency of carbon dioxide in the liquid of the order of 90%, said device and system of the present invention allow obtaining a dissolution efficiency of more than 97%, even greater than 99,9% (i.e., the dissolution efficiency is maximized due to the 1 to 1 ratio between the liquid volume and the gas volume), which means greater savings of CO₂ consumption for this type of process, more precisely, savings of the order of 30% to 40% of CO₂ consumption.

### Experimental Results

Below, tables of carbonation tests using the device of the present invention with two dissolution steps and a device of the prior art having a single dissolution step are shown. In particular, there are shown different tests under different conditions, the average of 100 samples being considered as the results for each test. In each of the tables below the variable Gas Volume (V/V) refers to the concentration (volume by volume) of gas in the carbonated liquid.

### Variable Flow and Pressure

In a first test, where the liquid entering the device had a pressure of 2 bar and a flow rate of 20 m³/h, the results shown in Table 3 were obtained.

TABLE 3

| | Priort Art | Present invention |
|---|---|---|
| Variables | Device | Device |
| CO₂ dissolution efficiency (%) | 93% | 97% |
| Gas Volume (V/V) | 1.7 V/V | 2.1 V/V |
| Pressure loss (g/cm²) | 750 | 350 |

In a second test, where the liquid entering the device had a pressure of 3 bar and a flow rate of 30 m³/h, the results shown in Table 4 were obtained.

TABLE 4

| | Priort Art | Present invention |
|---|---|---|
| Variables | Device | Device |
| CO₂ dissolution efficiency (%) | 91% | 98% |
| Gas Volume (V/V) | 2.6 V/V | 3.25 V/V |
| Pressure loss (g/cm²) | 980 | 370 |

In a third test, where the liquid entering the device had a pressure of 4 bar and a flow rate of 30 m³/h, the results shown in Table 5 were obtained.

TABLE 5

| | Priort Art | Present invention |
|---|---|---|
| Variables | Device | Device |
| CO₂ dissolution efficiency (%) | 91% | 98% |
| Gas Volume (V/V) | 2.6 V/V | 4.25 V/V |
| Pressure loss (g/cm²) | 1150 | 390 |

### Variable Temperature

In a fourth test, where the liquid entering the device had a pressure of 2 bar, a flow rate of 20 m³/h and a temperature of 6° C., the results shown in Table 6 were obtained.

TABLE 6

| | Priort Art | Present invention |
|---|---|---|
| Variables | Device | Device |
| CO₂ dissolution efficiency (%) | 94% | 98% |
| Gas Volume (V/V) | 1.8 V/V | 2.1 V/V |
| Pressure loss (g/cm²) | 750 | 350 |

In a fifth test, where the liquid entering the device had a pressure of 2 bar, a flow rate of 20 m³/h and a temperature of 12° C., the results shown in Table 7 were obtained.

TABLE 7

| | Priort Art | Present invention |
|---|---|---|
| Variables | Device | Device |
| CO₂ dissolution efficiency (%) | 90% | 97% |
| Gas Volume (V/V) | 1.7 V/V | 2.05 V/V |
| Pressure loss (g/cm²) | 750 | 350 |

In a sixth test, where the liquid entering the device had a pressure of 2 bar, a flow rate of 20 m³/h and a temperature of 18° C., the results shown in Table 8 were obtained.

TABLE 8

| | Priort Art | Present invention |
|---|---|---|
| Variables | Device | Device |
| CO₂ dissolution efficiency (%) | 91% | 98% |
| Gas Volume (V/V) | 1.4 V/V | 1.85 V/V |
| Pressure loss (g/cm²) | 750 | 350 |

From the results shown in each of the above tables it can be seen that the device of the present invention allows a considerable reduction in pressure loss in comparison with devices known in the prior art. In particular, the tables show reductions in pressure loss of up to about 66% (third test in Table 5).

1. A dissolution device comprising:
a tubular body comprising an inlet, an outlet and a side duct, said tubular body further comprising:
a first chamber fluidly connected to the side duct, and
a second chamber fluidly connected to said first chamber through a chamber junction conduit; and
a central body comprising an inlet portion and an outlet portion, said central body being located within the tubular body and attached to said tubular body;
wherein the tubular body and the central body define a passage therebetween through which fluid can flow,
wherein the first chamber is further fluidly connected to the passage through a first inner conduit and to an exterior of the tubular body through the side duct, and the second chamber is fluidly connected to the passage through a second inner conduit, and
wherein the dissolution device comprises two gas dissolution zones.

2. The dissolution device according to claim 1, wherein the first chamber, the second chamber and the chamber junction conduit surround a longitudinal axis of the dissolution device in an annular manner.

3. The dissolution device according to claim 1, wherein the central body comprises at a longitudinal end thereof an impact head where the fluid entering the tubular body through the inlet impacts.

4. The dissolution device according to claim 3, wherein the impact head comprises an angle of attack between 16° and 20°.

5. The dissolution device according to claim 1, wherein the passage comprises:
a first passage section extending from the impact head to the first inner conduit where the passage narrows as it approaches said first inner conduit, reaching a minimum width in the area where the passage and the first inner conduit connect, such narrowing of the passage occurring due to a widening of the inlet portion of the central body;
a second passage section extending from the first inner conduit to the second inner conduit, where the width remains constant for part of the second passage section and then gradually widens again as it approaches the second inner conduit as the width of the inlet portion of the central body becomes narrower, and wherein once the passage reaches the area where said passage and the second inner conduit connect, the passage widens or expands abruptly since the inner diameter of the tubular body increases; and
a third passage section extending from the second inner conduit, specifically from the abrupt widening of the passage, to an end of the outlet portion of the central body, wherein said third passage section remains substantially the same volume for a part of the outlet portion of the central body, and then widens as the outlet portion of the central body narrows towards the outlet of the tubular body.

6. The dissolution device according to claim 1, wherein the first inner conduit has an inlet angle of between 60° and 75°.

7. The dissolution device according to claim 1, wherein the second inner conduit comprises an upper surface having two surface sections inclined in opposite directions, each of said surface sections being defined by an angle, and said two surface sections generating a point of contact for greater discharge.

8. The dissolution device according to claim 7, wherein each of said surface sections is defined by an angle ranging from 15° to 20°.

9. The dissolution device according to claim 1, wherein the two gas dissolution zones comprise a first gas dissolution zone define by the zone where the first inner conduit flows into the passage, and a second gas dissolution zone define by the zone where the second inner conduit flows into the passage.

10. A dissolution system comprising:
a dissolution device being fluidly connected to a liquid container through liquid supply means, wherein said dissolution device comprises:
a tubular body comprising an inlet, an outlet and a side duct, said tubular body further comprising:
a first chamber fluidly connected to the side duct, and
a second chamber fluidly connected to said first chamber through a chamber junction conduit; and
a central body comprising an inlet portion and an outlet portion, said central body being located within the tubular body and attached to said tubular body;
wherein the tubular body and the central body define a passage therebetween through which fluid can flow,
wherein the first chamber is further fluidly connected to the passage through a first inner conduit and to an exterior of the tubular body through the side duct, and the second chamber is fluidly connected to the passage through a second inner conduit, and
wherein the dissolution device comprises two gas dissolution zones; and
a stabilizer tank fluidly connected to the dissolution device through the outlet of said dissolution device, said stabilizer tank being fluidly connected to a gas tank through gas supply means; and further fluidly connected to the side duct of the dissolution device.

11. The dissolution system according to claim 10, wherein the stabilizer tank comprises a pressure sensor.

12. The dissolution system according to claim 10, wherein the liquid supply means comprise a pump.
